(19) United States
(12) Patent Application Publication
(10) Pub. No.: US 2004/0018409 A1
(43) Pub. Date: Jan. 29, 2004

(54) Solid oxide fuel cell components and method of manufacture thereof

(76) Inventors: Shiqiang Hui, Storrs, CT (US); Xinqing Ma, Storrs, CT (US); Heng Zhang, Storrs, CT (US); Huimin Chen, Storrs, CT (US); Jeffrey Roth, Conventry, CT (US); John Broadhead, Holland, MA (US); Anthony DeCarmine, Lebanon, CT (US); Jinxiang Dai, Mansfield, CT (US); Danny T. Xiao, Willington, CT (US)

Correspondence Address: CANTOR COLBURN, LLP, 55 GRIFFIN ROAD SOUTH, BLOOMFIELD, CT, 06002

(21) Appl. No.: 10/377,253

(22) Filed: Feb. 28, 2003

Related U.S. Application Data
(60) Provisional application No. 60/361,184, filed on Feb. 28, 2002.

(51) Int. Cl. H01M 8/12; H01M 4/86; H01M 4/90; B05D 5/12; H01M 4/88

(52) U.S. Cl. 429/33; 429/40; 427/115; 502/101; 427/126.3; 427/126.6

(57) ABSTRACT

A solid oxide fuel cell comprises a dense electrolyte disposed between a porous anode and a porous cathode wherein the dense electrolyte comprises doped lanthanum gallate or yttria stabilized zirconia, the porous anode comprises yttrium-doped strontium titanate, yttrium-doped strontium titanate and nickel, lanthanum-doped ceria and nickel or yttria stabilized zirconia and nickel and the porous cathode comprises doped lanthanum ferrite or strontium-doped lanthanum manganite. The fuel cell may further comprise an interlayer(s) comprising lanthanum-doped ceria disposed between an electrode (anode, cathode or both) and the electrolyte. An interconnect layer comprising doped lanthanum chromate may be disposed between the anode of a first single fuel cell and the cathode of a second single fuel cell. The anode, cathode, electrolyte and optional interlayer(s) are produced by thermal spray.

### CROSS REFERENCE TO RELATED APPLICATIONS

This application claims priority to U.S. Provisional Application No. 60/361,184 filed on Feb. 28, 2002, which is incorporated herein by reference.

### STATEMENT OF GOVERNMENT INTEREST

This invention was made with Government support under grant DE-FG 02-01ER83340 awarded by the Department of Energy. The Government has certain rights in the invention.

### BACKGROUND OF THE INVENTION

This disclosure relates to solid oxide fuel cell components and methods for manufacturing solid oxide fuel cell components. In particular it relates to the manufacture of electrodes and electrolytes by thermal spray processes.

A fuel cell is a device in which a first reactant, a fuel such as hydrogen or a hydrocarbon, is electrochemically reacted with a second reactant, an oxidant such as air or oxygen, to produce a direct current (DC) electrical output. A fuel cell includes an anode, or fuel electrode, a cathode, or oxidant electrode, and an electrolyte. In a solid oxide fuel cell (SOFC), a solid electrolyte separates a porous anode from a porous cathode.

In such an SOFC, the fuel flowing to the anode reacts with oxide ions to produce electrons and water, which is removed in the fuel flow stream. Oxygen reacts with the electrons on the cathode surface to form oxide ions that diffuse through the electrolyte to the anode. The electrons flow from the anode through an external circuit and thence to the cathode. The electrolyte is typically a nonmetallic ceramic such as yttria-stabilized zirconica (YSZ) that is typically a poor or nonconductor of electrons, ensuring that the electrons must pass through the external circuit to do useful work. However, the electrolyte permits the oxide ions to pass through from the cathode to the anode.

Each individual fuel cell, made of a single anode, a single electrolyte, and a single cathode, generates a relatively small voltage. To achieve higher voltages that are practically useful, the individual fuel cells are connected together in series to form a stack. The fuel cell stack includes an electrical interconnect between the cathode and the anode of adjacent cells. The fuel cell assembly also includes ducts or manifolding to conduct the fuel, oxidant and reactant products into and out of the stack.

Numerous publications describe conventional SOFC which completely oxidize methane to carbon dioxide and water. These SOFC are designed to generate electricity from fuel gas and air (or oxygen). The processes conducted within SOFC are selected for essentially complete combustion rather than partial combustion and require completion of an external electric circuit or oxidation of fuel gas for continuous operation.

The typical SOFC comprises an anode made of a mixture of nickel metal and yttria stabilized zirconia (YSZ) and runs at temperatures greater than or equal to 1000° C. since internal reforming (conversion of light hydrocarbons to hydrogen) with these anodic materials is most efficient at these high temperatures. The ideal fuel for the anode is hydrogen but dangers of flammability, storage and energy storage density complicate its use. More commonly, the fuels used can be light hydrocarbons such as methane, propane, ethanol and methanol. In some cases the internal reforming is not efficient enough to reform the fuel and carbonaceous products are built up in the anode. The presence of carbonaceous products decreases the efficiency of the electrode.

There is an increasing desire in the industry to lower the operating temperature of the SOFC to 500-800° C. so that less exotic materials can be used for fuel cell construction. However, in lowering the temperature, the efficiency of the SOFC is also decreased, thereby leading to incomplete reforming of the fuel and consequent buildup of carbon and carbonaceous products in the anode. This problem is compounded when heavier fuels are utilized.

Accordingly there remains a need in the art for SOFC materials that can provide good efficiency on an economic basis in the temperature range of 500-800° C.

### SUMMARY OF THE INVENTION

The above mentioned drawbacks and disadvantages have been overcome and alleviated by a fuel cell comprising a dense nanostructured electrolyte disposed between a porous anode and a porous cathode wherein the dense electrolyte comprises doped lanthanum gallate or yttria stabilized zirconia, the porous anode comprises yttrium-doped strontium titanate, yttrium-doped strontium titanate and nickel, doped ceria, lanthanum-doped ceria and nickel, or yttria stabilized zirconia and nickel and the porous cathode comprises doped lanthanum ferrite or strontium-doped lanthanum manganite.

In another embodiment a fuel cell comprises a dense electrolyte disposed between a porous anode and a porous cathode wherein the dense electrolyte comprises doped lanthanum gallate or yttria stabilized zirconia, the porous anode comprises yttrium-doped strontium titanate, yttrium-doped strontium titanate and nickel, doped ceria, lanthanum-doped ceria and nickel or yttria stabilized zirconia and nickel and the porous cathode comprises doped lanthanum ferrite or strontium-doped lanthanum manganite and further wherein the anode, cathode, electrolyte or a combination of two or more of the foregoing are nanostructured.

In another embodiment, a fuel cell comprises a dense electrolyte comprising doped lanthanum gallate disposed between a porous nanostructured mixed ionic electronic conducting anode and a porous cathode comprising doped lanthanum ferrite or strontium-doped lanthanum manganite.

The above described fuel cells may further comprise an interlayer(s) comprising lanthanum-doped ceria disposed between an electrode (anode, cathode or both) and the electrolyte. An interconnect layer comprising doped lanthanum chromate may be disposed between the anode of a first single fuel cell and the cathode of a second single fuel cell.

In another embodiment a method to produce a solid oxide fuel cell comprises thermally spraying a material comprising yttrium-doped strontium titanate, yttrium-doped strontium titanate and nickel, doped ceria, lanthanum-doped ceria and nickel or yttria stabilized zirconia and nickel to form a porous anode; thermally spraying a material comprising doped lanthanum gallate or yttria stabilized zirconia to form a dense electrolyte and thermally spraying a material comprising doped lanthanum ferrite or strontium-doped lanthanum manganite to form a porous cathode wherein the electrolyte is disposed between the cathode and the anode. The method may further comprise thermally spraying an active material to form an interlayer(s) which is disposed between an electrode (anode, cathode or both) and the electrolyte.

These and other features will be apparent from the following brief description of the drawings, detailed description, and attached drawings.

### BRIEF DESCRIPTION OF THE DRAWINGS

FIG. 1 is a schematic representation of a planar solid oxide fuel cell.

FIG. 2 is a schematic representation of a planar solid oxide fuel cell having interlayers.

FIG. 3 is a schematic representation of a tubular solid oxide fuel cell.

FIG. 4 is a schematic representation of a tubular solid oxide fuel cell having interlayers.

FIG. 5 is TEM micrographs showing the microstructures of nanostructured yttrium-doped strontium titanate synthesized by (a) wet chemical synthesis, and (b) solid-state-reaction.

FIG. 6 is SEM micrographs showing morphologies of reconstituted SYT feedstock powders.

FIG. 7 is an SEM micrograph of a sequentially sprayed fuel cell.

FIG. 8 is an SEM micrograph of a dense doped lanthanum manganite electrolyte.

FIG. 9 is a graph depicting the open circuit voltage corresponding to the single cell in FIG. 7.

### DETAILED DESCRIPTION OF THE INVENTION

A method to produce a solid oxide fuel cell comprises thermally spraying a material comprising yttrium-doped strontium titanate (SYT), yttrium-doped strontium titanate and nickel, doped ceria, lanthanum-doped ceria (LDC) and nickel or yttria stabilized zirconia (YSZ) and nickel to form a porous anode; thermally spraying a material comprising doped lanthanum gallate (La_{0.8}Sr_{0.2}Ga_{0.8}Mg_{0.2}O_{3-θ}, LSGM) or yttria stabilized zirconia to form a dense electrolyte and thermally spraying a material comprising strontium-doped lanthanum manganite (La_{0.8}Sr_{0.2}MnO₃, LSM) or doped lanthanum ferrite to form a porous cathode wherein the electrolyte is disposed between the cathode and the anode. The electrolyte, anode, cathode or a combination of two or more of the foregoing may be nanostructured. Nanostructured is herein defined as consisting of subparticles (or grains) with a maximum size of 100 nanometers. In nanostructured materials a significantly higher percentage of the atoms reside at the grain boundary than in microstructured materials.

The fuel cell may further comprise an interlayer(s) comprising a dense material, preferably lanthanum-doped ceria, disposed between an electrode (anode, cathode or both) and the electrolyte. Preferably the interlayer dense material is catalytically active in the internal reforming process. The optional interlayer may also be formed by thermal spray methods. An optional interconnect layer comprising doped lanthanum chromite may be disposed between two adjacent fuel cells.

The solid oxide fuel cell may be operated at high temperatures (above 1000° C.) or at intermediate temperatures (about 500 to 800° C.). When operated at intermediate temperatures the solid oxide fuel cell exhibits stable performance over long periods of time. The electrodes, electrolyte and optional interlayer and interconnect materials are stable at these temperatures and there is little or no carbonaceous deposition at the anode to impede performance.

Thermal spray methods have been developed to permit the formation of both dense layers and porous layers. The thermal spray methods can employ conventional microstructured, micrometer-sized feedstocks but can also employ nanostructured materials and precursor solutions as feedstocks. Use of nanostructured feedstocks can produce nanostructured electrodes and electrolytes. The nanostructured feedstocks may be provided by reprocessing nanoparticles by the methods described in U.S. Pat. No. 6,025,034, which is incorporated by reference. The reprocessing described in U.S. Pat. No. 6,025,034 results in micrometer sized agglomerates of the nanoparticles. Unexpectedly, thermal spray of the nanostructured feedstock does not result in microstructured electrodes and electrolytes. Instead the thermal spray of the nanostructured feedstock results in a nanostructured electrode or electrolyte.

Dense layers are characterized by having less than or equal to about 9%, preferably less than or equal to about 5%, and most preferably less than or equal to about 2% porosity, based on the total volume of the layer and porous layers are characterized by having greater than or equal to about 22% and preferably greater than or equal to about 25% porosity, based on the total volume of the layer. With the development of techniques to form both dense and porous layers by a single application technique, the fabrication costs of the SOFC can be greatly reduced. SOFCs may now be produced in a single consecutive spray process using only one piece of equipment by spraying the desired materials with controlled porosity. Thermal spray techniques offer the additional advantage of having higher deposition rates than other methods such as chemical vapor deposition that are currently used to fabricate SOFCs.

The initial layer of the SOFC materials is typically applied to a substrate. The initial layer may comprise part of the cathode, anode or electrolyte, preferably the anode or cathode. Subsequent layers are deposited on the initial layer in a consecutive fashion in the desired order. To form a free standing SOFC the substrate comprises a material that can later be removed. Examples of removable materials include metals soluble in solutions that will not affect the deposited material and salt film coated materials. After application is complete the substrate is removed by dissolving it in an appropriate solution such as base or water. Preferred substrates include aluminum, salt coated metals, salt coated ceramics and salt coated composites. As will readily be appreciated by one of ordinary skill in the art, it is preferred for the substrate to be inert to the applied material under application conditions. If desired the cathode, anode and electrolyte materials may be applied directly to a bipolar plate thereby obviating the need for a removable substrate. The substrate may be degreased by standard methods such as rinsing with an organic solvent. An exemplary organic solvent is acetone. The substrate may also be coarsened by techniques such as sand blasting.

The plasma working gas for thermal spray is chosen to produce sufficient power based on the feed rate to result in the desired porosity and bond strength. Typically the plasma working gas is a mixture of argon and helium or argon and hydrogen. The mixture of argon and helium generates a plasma flame with more homogeneous heating than is typically achievable with standard gas mixtures. To obtain the maximum amount of plasma power the helium flow rate is high, typically about 150 to about 200 standard cubic feet per hour (SCFH). The argon flow rate is typically about 80 to about 120 SCFH.

To thermal spray a dense layer, a low powder feed rate is used in order to provide a coating rate of less than about 10 micrometers per pass. The powder feed rate is about 0.5 to about 1.5 pounds per hour (lb/hr). The low powder feed rate promotes greater heat transfer between the flame and the powder particles than a high powder feed rate. The feedstock has a particle size of about 10 to about 60 and preferably about 20 to about 30 micrometers. The feedstock may be microstructured wherein each particle comprises subparticles that are greater than or equal to one micrometer in size but preferably the feedstock is nanostructured wherein each particle comprises subparticles that are less than or equal to 100 nanometers in size. The stand off distance and spray angle are typically those employed when thermal spraying ceramic materials. The traverse rate is about 500 to about 1200 millimeters/sec. The low traverse rate enhances heat input into the deposit. Preferably the substrate is preheated and maintained at a temperature above about 200° C. The combination of the low powder feed rate, the low traverse rate and substrate heating results in in situ micro sintering. Optionally the deposited material may be subjected to a post deposition heat treatment for further sintering. In an especially advantageous feature, the dense layer may be nanostructured and comprise grains less than 100 nanometers in size.

In an alternative embodiment, a dense layer may be produced by thermal spray using a feedstock comprising solution precursors. Solution precursors include organometallic, polymeric, and inorganic salts materials that under the conditions of thermal spray react to form the deposited material. Preferred inorganic salts are nitrates, chlorides and acetates. Thermal spray employing solution precursors is described in co-assigned, co-pending U.S. patent application Ser. Nos. 60/439,288 and 60/439,399 and co-assigned U.S. Pat. No. 6,447,848, which are incorporated by reference herein in their entirety. Advantageously, the dense layers resulting from thermal spray using solution precursors have a smooth surface and uniform thickness. Similar to the powder feed method of creating a dense layer the substrate is heated prior to and during the coating process. The dense layer may be nanostructured and comprise grains less than 100 nanometers in size.

The porous electrodes are produced using thermal spray with a powder feed. In some embodiments, the powder feed may include a pore-forming material useful in forming pores. The pore-forming material may be any material capable of forming a pore under thermal spray conditions. Exemplary pore-forming materials include metal metasilicates such as sodium metasilicate and high temperature polymers. When the pore-forming material is present, the spray nozzle is typically positioned at about a ninety degree angle to the substrate. When the pore-forming material is absent, the nozzle is usually positioned at a small angle to the substrate, typically less than or equal to about forty-five degrees. The pore-forming material, when present, may be removed in a post heat treatment process or by a solvent wash. The powder feed rate is about 6 to about 12 lb/hr. The feedstock preferably has a particle size of about 10 to about 120 and preferably about 75 to about 120 micrometers. The feedstock may be microstructured or nanostructured. A large standoff distance, typically about 6 to about 8 inches is used. The standoff distance is the distance between the nozzle and the substrate. Preferably the substrate is kept at a temperature less than or equal to about 300° C., more preferably less than or equal to about 250° C., and more preferably less than or equal to about 100° C., through the use of a cooling jet or similar technology. It is believed that the traverse speed is not critical to the production of a porous material. The porous electrode may be nanostructured and comprise grains less than 100 nanometers in size.

In an alternative embodiment, a porous electrode may be produced by thermal spray using a feedstock comprising solution precursors. Solution precursors include organometallic, polymeric, and inorganic salts materials that under the conditions of thermal spray react to form the deposited material. Preferred inorganic salts are nitrates, chlorides and acetates. Thermal spray employing solution precursors is described in co-assigned, co-pending U.S. patent application Ser. Nos. 60/439,288 and 60/439,399 and co-assigned U.S. Pat. No. 6,447,848, which are incorporated by reference herein in their entirety. Advantageously, the porous layers resulting from thermal spray using solution precursors have a smooth surface and uniform thickness. Similar to the powder feed method of creating a porous layer the substrate is cooled during the coating process. The porous electrode may be nanostructured and comprise grains less than 100 nanometers in size.

The fuel cell produced by the above described method comprises a dense electrolyte disposed between two porous electrodes. As described above, the anode, cathode, electrolyte, or a combination of two or more of the foregoing may be nanostructured. Preferably, at least the electrolyte is nanostructured. The electrolyte comprises doped lanthanum gallate, yttria stabilized zirconia or a combination of the foregoing.

The dense electrolyte layer typically has a thickness of about 20 to about 200 micrometers. Within this range the thickness is preferably greater than or equal to about 50, more preferably greater than or equal to about 80 micrometers. Also within this range the thickness is preferably less than or equal to about 150, more preferably less than or equal to about 120 micrometers.

The cathode and anode may independently be nanostructured or non-nanostructured although it is preferred for the cathode, anode or both to be nanostructured. In one embodiment, the anode, cathode or both anode and cathode comprise a nanostructured mixed ionic electronic conducting (MIEC) material. Exemplary MIEC materials for use in anodes include, but are not limited to, yttrium-doped strontium titanate, niobium-doped strontium titanate, yttrium/niobium-codoped strontium titanate and doped ceria using dopants such as lanthanum, yttrium, samarium, scandium, and praseodymium. Exemplary MIEC materials for use in a cathode include, but are not limited to, perovskite oxides.

The porous electrodes have a thickness of about 10 to about 200, preferably about 10 to about 100, and more preferably about 10 to about 50 micrometers. In some embodiments the electrodes may have unequal thicknesses while in other embodiments the electrodes may have equal thicknesses.

The fuel cell may comprise an optional interlayer. The optional interlayer typically comprises lanthanum-doped ceria and is located between an electrode (anode, cathode or both) and the electrolyte. The interlayer is dense and may be produced using the thermal spray methods described above. The interlayer is preferably used when the anode or cathode comprises nickel and the electrolyte comprises doped lanthanum gallate. Nickel can react with doped lanthanum gallate and the presence of an interlayer can prevent the reaction. The interlayer has a thickness of about 5 to about 50 micrometers, preferably about 5 to about 20 micrometers and more preferably about 5 to about 10 micrometers.

It is also contemplated that the fuel cell may be made by combining materials made by thermal spray with materials made by other methods. For example, an electrolyte could be thermally sprayed onto a commercially available electrode made by non-thermal spray methods to form an electrode/electrolyte combination. The remaining electrode could then be applied to the electrolyte of the electrode/electrolyte combination by thermal spray or the electrode/electrolyte combination could be combined with a second electrode made by non-thermal spray methods.

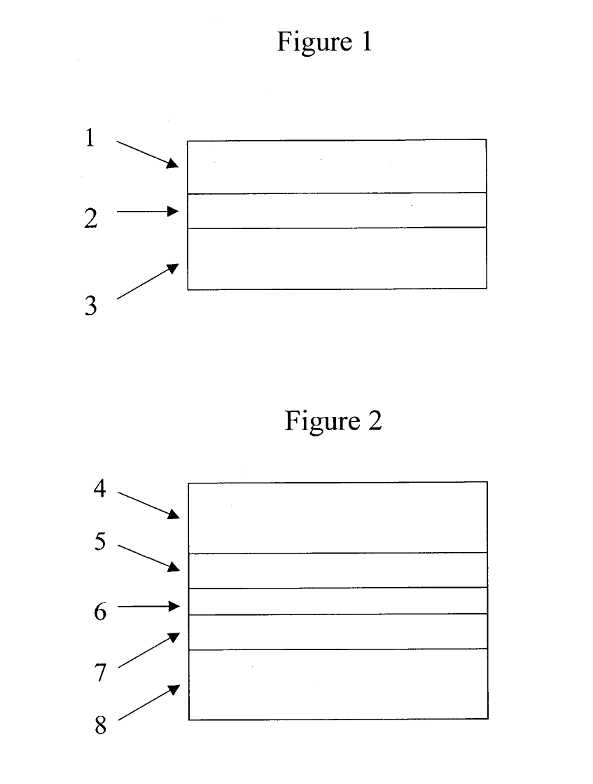

Turning now to the figures, FIG. 1 is a schematic representation of a planar solid oxide fuel ell in which electrolyte 2 is disposed between anode 1 and cathode 2. FIG. 2 is a schematic representation of a planar solid oxide fuel cell having interlayers. Electrolyte 6 is located between interlayer 5, which is adjacent to anode 5, and interlayer 7, which is adjacent to cathode 8. While it is not shown, it is contemplated that solid oxide fuel cells comprising only one interlayer, located between the electrolyte and anode or between the electrolyte and cathode, may also be useful.

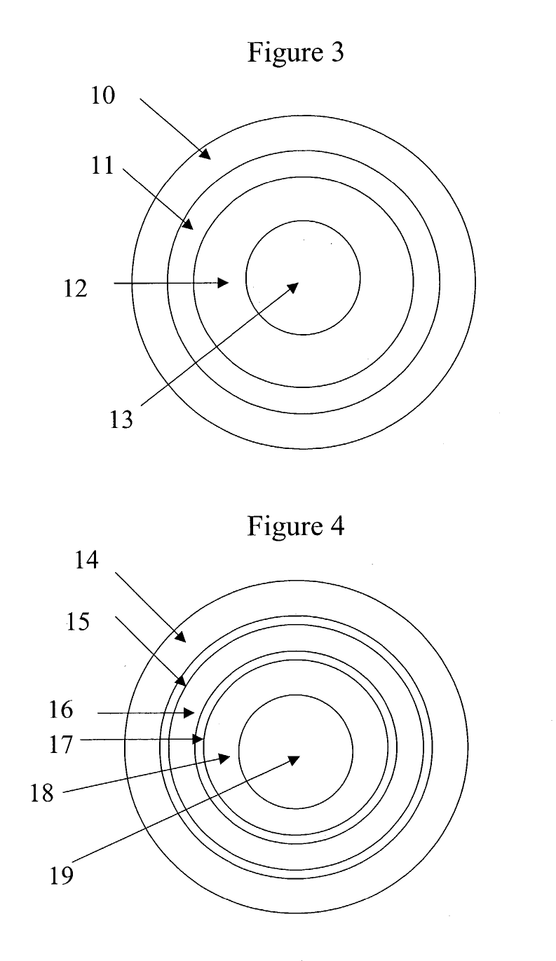

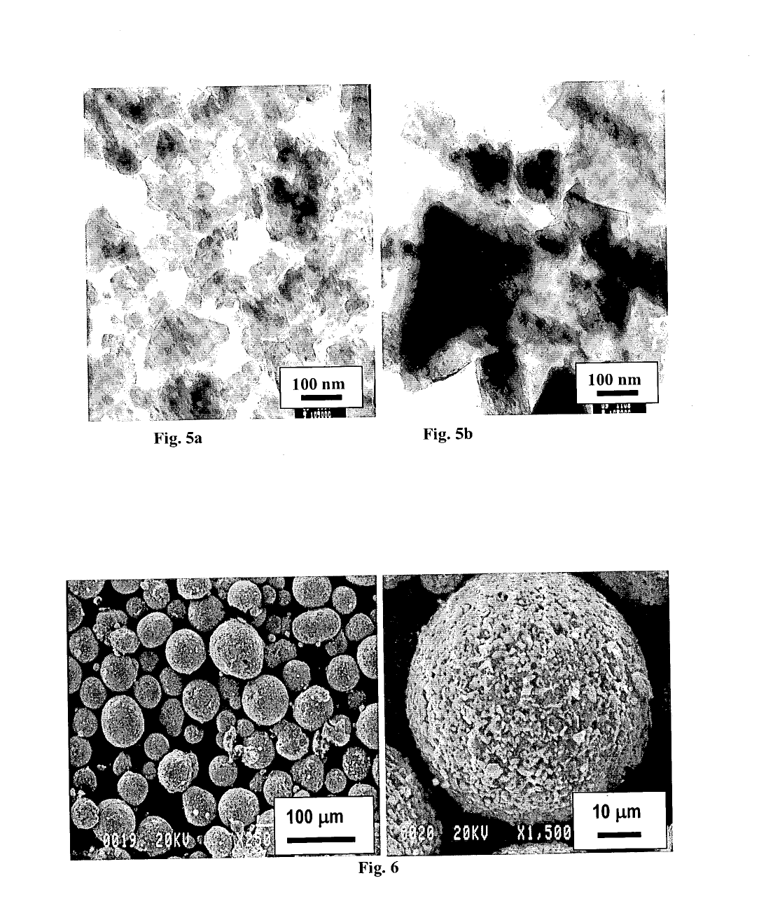

FIG. 3 is a cross section of a tubular solid oxide fuel cell in which electrolyte 10 is disposed between anode 10 and cathode 12. Cathode 12 surrounds air feed 13. FIG. 4 is a cross section of a tubular solid oxide fuel cell having interlayers. Electrolyte 16 is located between interlayer 15, which is adjacent to anode 14, and interlayer 17, which is adjacent to cathode 18. Cathode 18 surrounds air feed 19.

FIG. 7 is a scanning electron microscope (SEM) micrograph of a sequentially sprayed fuel cell. Dense electrolyte 21 comprises doped lanthanum gallate and is located between porous anode 20 comprising yttrium-doped strontium titanate and prorous cathode 22 comprising strontium-doped lanthanum manganite.

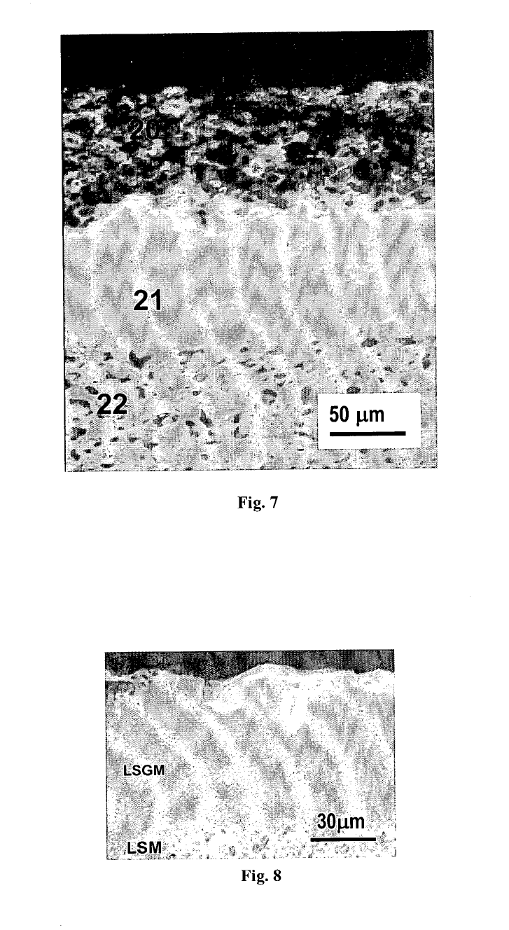

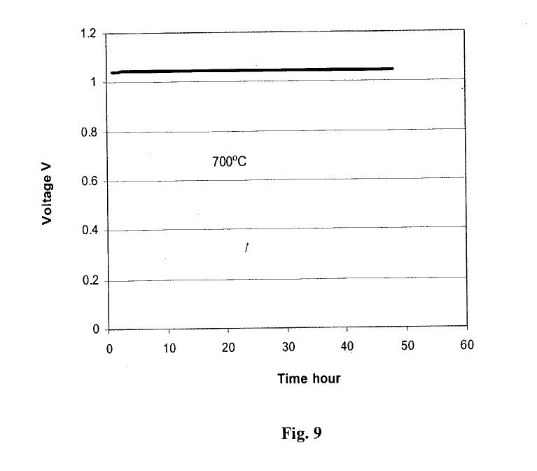

FIG. 8 is a SEM micrograph of a dense electrolyte comprising doped lanthanum gallate disposed on a porous cathode comprising doped lanthanum manganite.

FIG. 9 is a graph depicting the open circuit voltage corresponding to the single cell in FIG. 7 over many hours. The steady voltage is characteristic of a fuel cell having a dense electrolyte.

The disclosure is further illustrated by the following non-limiting examples.

### EXAMPLES

### Example 1.

### Synthesis of Nanostructured Yttrium-doped Strontium Titanate (SYT) Powders

SYT powders were prepared using both a solution synthesis method and a solid state method. Synthesis of nanostructured SYT powder using a solution synthesis method proceeded by the following steps.

1. A solution of yttrium, titanium, and strontium containing precursors in ethylene glycol was prepared.

2. The precursors were reacted at 60° C. to form a preceramic gel-like powder that contained a Sr—Y—Ti—O complex.

3. The Sr—Y—Ti—O complex was calcined at 350° C. to form to form an intermediate SYT powder.

4. The intermediate powder was calcined at 650° C. to form nanostructured SYT anode material.

In the synthesis of SYT using a solid state reaction route SrCO₃, Y₂O₃ and TiO₂ were mixed uniformly using a ball milling process. The powder mixture was then pressed into solid pellets (1 inch diameter) using a hydraulic press under a pressure of 5000 psi. Then the pellets were sintered at 1400° C. for 12 hours under an air atmosphere. The pellets were crushed and ball milled. Typical microstructures of the synthesized SYT materials are shown in FIG. 5.

### Example 2

### Reprocessing of Nanostructured SYT Powders Into Sprayable Feedstocks

Nanostructured SYT powders were reconstituted into feedstocks suitable for thermal spray. The reconstitution steps included dispersing SYT nanoparticles in deionized water to form a viscous slurry, adding surfactants and polyvinyl alcohol (PVA) binders to form a stable and uniform slurry, spray drying the slurry to form highly flowable micrometer sized spherical particles, and heating at a low temperature to remove organic binders and promote partial sintering with controlled inter-particle porosity. The micrometer sized spherical particles were nanostructured (assemblage of many individual nanoparticles, particles less than 100 nanometers in size). Typical scanning electron microscope (SEM) micrographs of the reconstituted SYT are shown in FIG. 6.

### Example 3

### Formation of Nanostructured SYT Anode Layer Via Plasma Spray

Nanostructured SYT was synthesized and spray dried into spheres with a particle size distribution of 20-50 micrometers as described in Examples 1 and 2. An air plasma spray system (9 MB model, Metco) was used to apply an SYT coating on a blasted aluminum substrate. Because SYT is stable in a reductive atmosphere, a plasma gas composition consisting of argon and hydrogen was used as the plasma working gas. The nozzle was a GH-type nozzle (relatively low velocity, Sulzer-Metco). The gun was set at a low angle to the substrate, about 30-45 degrees, in order to increase layer porosity. A cooling jet was employed to keep the substrate temperature below about 250° C. during the spray process. A relatively high gun traverse speed was selected. The plasma spraying parameters for SYT are given as below.

| | |
|---|---|
| Plasma gases: | Primary gas: Ar 65-75 pounds per square |
| | inch (PSI), 120-150 standard cubic feet per |
| | hour (SCFH) |
| | Secondary gas: H₂ 40-50 PSI, 10-20 SCFH |
| Plasma power: | 20-27 kilowatts (KW) (450-500 amps |
| | (A)/45-55 volts (V)) |
| Standoff distance: | 6-8 inches |
| Gun speed, traverse speed: | 1000-1200 millimeters per second (mm/s), |
| | vertical speed, 6-10 mm/s |
| Powder feed rate: | 12-15 pounds per hour (lb/hr) |
| Substrate temperature: | No preheating; during spraying, 150-250° C. |

### Example 4

### Formation of Porous LSM Cathode Layer Via Plasma Spray

La₁₋ₓ SrₓMnO₃ (LSM) was provided by Praxair of Danbury, Connecticut. An air plasma spray system (9 MB model, Metco) was used to apply an LSM coating on blasted aluminum substrate. Only argon was used as plasma working gas together with a GH-type nozzle (relatively low velocity, Sulzer-Metco). The plasma spraying parameters for LSM are given as below.

| | |
|---|---|
| Plasma gas: | Ar 65-75 PSI, 80-100 SCFH |
| Plasma power: | 24-35 KW (400-500 A/60-70 V) |
| Standoff distance: | 6-8 inches |
| Gun speed, traverse speed: | 500-600 mm/s; vertical speed, 4-8 mm/s |
| Powder feed rate: | 6-12 lb/hr |
| Substrate temperature: | No preheating; during spraying, 150-250° C. |

The sprayed LSM layer had a porosity of 25-35%, and a thickness of about 200-300 micrometers. The porous structure was characterized by scanning electron microscopy.

### Example 5

### Formation of Dense 7 YSZ Electrolyte Layer Via Plasma Spray

ZrO₂-7 wt %Y₂O₃ material (7 YSZ) (spray dried spherical powder available from Metco 204NS) was used as feedstock. Metco plasma spray system (9 MB mode) was used to form a dense 7 YSZ layer on a previously sprayed porous LSM cathode layer and a sintered LSM tube. A plasma gas composition consisting of argon and helium was used as the plasma working gas. The nozzle was a G-type nozzle. Powder was fed at a low rate that corresponded to a deposition rate of about 5 micrometers/pass. The substrate was preheated and heating was continued during spraying. After spraying, the layered material was subjected to a post spraying heat treatment at 800° C. in air for about an hour, in order to increase the layer density, crystallinity and integrity. The 7 YSZ layer had a density of more than 95%, and a thickness of about 50 micrometers. The primary plasma spraying parameters for 7 YSZ material are given as below.

| | |
|---|---|
| Plasma gases: | Primary gas Ar, 80-100 PSI, 80-120 SCFH |
| | Secondary gas He, 40-50 PSI, |
| | 200-220 SCFH |
| Plasma power: | 30-39 KW (650-700 A/45-55 V) |
| Standoff distance: | 1.5-2.5 inches |
| Gun speed, traverse speed: | 500-600 mm/s, vertical speed, 1-2 mm/s |
| Powder feed rate: | 0.5-1.5 lb/hr |
| Substrate temperature: | In preheating, 200-300° C., during spraying, |
| | 300-500° C. |

### Example 6

### Formation of Dense 20 YSZ Electrolyte Via Plasma Spray

ZrO₂-20 wt %Y₂O₃ material (20 YSZ) was synthesized and spray dried into feedstock with a particle size of about 5-25 micrometers. The feedstock was sprayed onto a LSM substrate to form a dense electrolyte layer about 100 micrometers thick. The primary plasma spraying parameters for 20 YSZ were given as below.

| | |
|---|---|
| Plasma gases: | Primary gas Ar, 80-100 PSI, 80-120 SCFH |
| | Secondary gas He, 40-50 PSI, |
| | 200-220 SCFH |
| Plasma power: | 30-39 KW (650-700 A/45-55 V) |
| Standoff distance: | 1.5-2.5 inches |
| Gun speed, traverse speed: | 500-600 mm/s, vertical speed, 1-2 mm/s |
| Powder feed rate: | 0.5-1.5 lb/hr |
| Substrate temperature: | preheating 200-300° C.; during spraying, |
| | 200-300° C. |

### Example 7

### Formation of Dense LSGM Electrolyte Layer Via Plasma Spray

LSGM (a spray dried spherical powder available from Praxair) was used as feedstock. Air plasma spray system (9 MB model, Metco) was employed to form a dense LSGM electrolyte layer on a sprayed LSM layer and a porous LSM tube. The LSM tube was blasted with #30 Al₂O₃ grit prior to spraying. A mixture of argon and helium gases was used with a G-type nozzle (Sulzer-Metco) to generate a hot and high-velocity plasma flame. A low powder feeding rate was used (0.5-1.5 lb/hr) which corresponded to a deposition rate of 5-10 micrometers/pass. The substrate was heated up to a temperature above 250° C. in preheating process and was kept constantly “hot” during the spray process. A small standoff distance and low gun traverse speed were selected. The typical plasma spraying parameters for LSGM are given as below.

| | |
|---|---|
| Plasma gases: | Primary gas: Ar, 80-100 PSI, |
| | 120-150 SCFH |
| | Secondary gas: He, 40-50 PSI, |
| | 180-220 SCFH |
| Plasma power: | 27-36 KW (600-650 A/45-55 V) |
| Standoff distance: | 2-3.5 inches |
| Gun speed, traverse speed: | 500-600 mm/s; vertical speed, 1-3 mm/s |
| Powder feed rate: | 0.5-1.5 lb/hr |
| Substrate temperature: | In preheating, 200-300° C.; during spraying, |
| | 300-500° C. |

The resultant LSGM layer had a density of more than 98%, and a minimum thickness of about 20 micrometers. A post heat treatment at 500-800° C. obtained complete crystallization of the LSGM layer. A minimally cracked structure and well-bonded interface were characterized by scanning electron microscopy.

### Example 8

### Formation of YSZ+Ni Anode Layer Via Plasma Spray

Composite YSZ +Ni (20 and 30 volume % based on the total volume of the composite) powders were produced by blending the two spray dried powders mechanically and then spraying the mixture by plasma spray onto a LSGM electrolyte layer disposed on a LSM cathode layer. The LSGM electrolytes layer was produced by the method described in Example 7 and the LSM cathode layer was produced by the method described in Example 4. By reducing the hydrogen flow rate, the plasma power was adjusted to a relatively low value to produce a porous YSZ+Ni layer. The process parameters for the spraying of YSZ+Ni composite are given as below.

| | |
|---|---|
| Plasma gases: | Ar: 65-75 PSI, 80-100 SCFH |
| | H₂: 40-50 PSI, 20-25 SCFH |
| Plasma power: | 24-35 KW (400-500 A/60-70 V) |
| Standoff distance: | 6-8 inches |
| Gun speed: traverse speed: | 500-600 mm/s; vertical speed, 4-8 mm/s |
| Powder feed rate: | 6-12 lb/hr |
| Substrate temperature: | No preheating, during spraying, 150-250° C. |

### Example 9

### Formation of SYT+Ni Anode Layer Via Plasma Spray

A SYT+80 weight %Ni based on the total weight of the composite (about 40 vol%) composite was fabricated by mechanically mixing the SYT and the nickel and was air plasma sprayed on an LSGM electrolyte layer disposed on an LSM cathode layer. The LSGM electrolyte layer disposed on an LSM cathode layer was prepared as described in Example 7. A mixture of argon and hydrogen were used as the plasma working gas with a GH-type nozzle. The plasma spraying parameters for forming SYT+Ni anode layer is given as below.

| | |
|---|---|
| Plasma gases: | Ar, 65-75 PSI, 80-100 SCFH |
| Plasma power: | 24-35 KW (400-500 A/60-70 V) |
| Standoff distance: | 6-8 inches |
| Gun speed: traverse speed: | 500-600 mm/s; vertical speed, 4-8 mm/s |
| Powder feed rate: | 6-12 lb/hr |
| Substrate temperature: | No preheating; during spraying, 150-250° C. |

### Example 10

### Formation of LSM+LSGM Cathode Layer Via Plasma Spray

LSM was mixed mechanically with LSGM at a ratio of 50 to 50 in volume, and used for the fabrication of a porous cathode layer by air plasma spraying. The spray process is the same used for LSM material. The plasma spraying parameters are given as below:

| | |
|---|---|
| Plasma gas: | Ar: 65-75 PSI, 80-100 SCFH |
| Plasma power: | 24-35 KW (400-500 A/60-70 V) |
| Standoff distance: | 6-8 inches |
| Gun speed: traverse speed: | 500-600 mm/s; vertical speed, 4-8 mm/s |
| Powder feed rate: | 6-12 lb/hr |
| Substrate temperature: | No preheating; during spraying, 150-250° C. |

The sprayed LSM+LSGM layer had a porosity of 20-30%, and a thickness of about 100-200 micrometers.

### Example 11

### Formation of 7 YSZ Electrolyte Layer Via Liquid Spray

ZrO₂+7 wt %Y₂O₃ (7YSZ) layer was sprayed on a substrate in a liquid plasma spray process. The liquid precursor was made from the mixing of zirconium acetate solution (22.2 wt %ZrO₂) with yttrium nitrate. A gas pump with a pressure of 20 pounds per square inch (psi) was employed to deliver the liquid to the atomizing injector that was attached to the plasma nozzle. The substrates used included carbon steel, stainless steel, superalloy and a sprayed LGM cathode layer. The substrate temperature was controlled in preheating and spray processes by using a plasma torch or an external heater. A high quality electrolyte layer with a full density, small thickness (2-10 micrometers/pass), low surface roughness and a well-bonded interface was formed. The primary parameters for the spraying of dense/thin YSZ electrolyte layer include:

| | |
|---|---|
| Liquid feeding rate: | 20 PSI, 20-60 ml/min. |
| Atomizing gas: air, | 10-20 PSI |
| Injection: | Conical dispersion-type |
| Plasma gases: | Ar, 80-100 PSI, 100-160 SCFH |
| Plasma power: | 36-46 KW (600-650 A/60-70 V) |
| Standoff distance: | 2-4 inches |
| Gun speed, traverse speed: | 500-1000 mm/s; vertical speed, 2-4 mm/s |
| Substrate temperature: | preheating, 300-400° C.; during spraying, |
| | 400-600° C. |

### Example 12

### Formation of 20 YSZ Electrolyte Layer Via Liquid Spray

ZrO₂+20 wt %Y₂O₃ (20 YSZ) layer was sprayed onto LGM tube (inner diameter 0.66 inch, outer diameter 0.85 inch) in a liquid plasma spray process. The sintered LGM tube was porous. Prior to applying YSZ electrolyte, the tube was degreased with acetone, then sand blasted with fine grit such as #150 grit to obtained a fresh surface. The tube was fixed on a turntable and rotated at a speed of 150 rotations per minute (rpm). Preheating was performed by using plasma torch that scanned vertically at a speed of 4 millimeters/s. The spray system setup and parameters are the same as described in Example 11.

### Example 13

### Formation of LDC Interlayer Via Plasma Spray

Nanostructured lanthanum-doped ceria (LDC40) was synthesized by a solution method similar to the one described in Example 1. The synthesized powder was spray dried into spheres with a particle size distribution of 20-50 micrometers. An air plasma spray system (9 MB model, Metco) was used. Because LDC40 is stable in a reductive atmosphere, a plasma gas composition consisting of argon and hydrogen was used as plasma working gases. A GH-type nozzle (relatively low velocity, Sulzer-Metco) was used. The gun was set at a low angle to the substrate, about 30-45° C., in order to increase layer porosity. The substrate was kept at a relatively low temperature during the spray process. A relatively high gun traverse speed was selected. The material was coated on top of an electrolyte and the thickness of the interlayer was about 20 micrometers. Plasma spraying parameters for LDC material are given below:

| | |
|---|---|
| Plasma gases: | Primary gas Ar, 65-75 PSI, 120-150 SCFH |
| | Secondary gas H₂, 40-50 PSI, 10-20 SCFH |
| Plasma power: | 20-27 KW (450-500 A/45-55 V) |
| Standoff distance: | 6-8 inches |
| Gun speed: traverse speed: | 1000-1200 mm/s; vertical speed, 6-10 mm/s |
| Powder feed rate: | 2-15 lb/hr |

### Example 14

### Formation of a Five-Layer Fuel Cell Unit

A LSM cathode was prepared either by thermal spraying of LSM feedstock onto planar Al substrate using the method disclosed in Example 5 or using a sintered LSM tube. A thin LDC40 interlayer was applied by using a mixture of argon and hydrogen as plasma working gases as described in Example 13. The spray process uses a low powder feeding and low plasma power input. The interlayer had a thickness of about 5-10 micrometers. A dense LSGM electrolyte layer was formed with a density of about 98-100% and a thickness of 20-50 micrometers as described in Example 7. A second thin LDC40 interlayer was applied on the top of the LSGM electrolyte layer. In the final step, a porous YSZ+Ni anode layer was applied in a reductive atmosphere by using a plasma gas mixture containing hydrogen as secondary gas.

### Example 15

### Formation of a Four-Layer Fuel Cell Unit

A dense LSGM layer was thermal sprayed on a sintered LSM tube using the method described in Example 7. A thin LDC40 interlayer was applied to the LSGM layer as described in Example 14. A porous LDC40-Ni layer was thermal sprayed onto the interlayer.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

We claim:

1. A fuel cell comprising a dense nanostructured electrolyte disposed between a porous anode and a porous cathode wherein the dense electrolyte comprises doped lanthanum gallate or yttria stabilized zirconia, the porous anode comprises yttrium-doped strontium titanate, yttrium-doped strontium titanate and nickel, doped ceria, lanthanum-doped ceria and nickel, or yttria stabilized zirconia and nickel and the porous cathode comprises doped lanthanum ferrite or strontium-doped lanthanum manganite.

2. The fuel cell of claim 1 further comprising an interlayer disposed between the electrolyte and the cathode.

3. The fuel cell of claim 1 further comprising an interlayer disposed between the electrolyte and the anode.

4. The fuel cell of claim 1, wherein the dense electrolyte has a porosity less than or equal to about 9%, based on the total volume of the electrolyte.

5. The fuel cell of claim 4, wherein the dense electrolyte has a porosity less than or equal to about 5%, based on the total volume of the electrolyte.

6. The fuel cell of claim 5, wherein the dense electrolyte has a porosity less than or equal to about 2%, based on the total volume of the electrolyte.

7. The fuel cell of claim 1, wherein the porous cathode, porous anode or both of the foregoing has a porosity greater than or equal to about 22%, based on the total volume of the electrode or electrodes.

8. The fuel cell of claim 1, wherein the electrolyte layer has a thickness of about 20 to about 200 micrometers.

9. The fuel cell of claim 1, wherein the cathode has a thickness of about 10 to about 200 micrometers.

10. The fuel cell of claim 1, wherein the anode has a thickness of about 10 to about 200 micrometers.

11. A fuel cell comprising a dense electrolyte disposed between a porous anode and a porous cathode wherein the dense electrolyte comprises doped lanthanum gallate or yttria stabilized zirconia, the porous anode comprises yttrium-doped strontium titanate, yttrium-doped strontium titanate and nickel, doped ceria, lanthanum-doped ceria and nickel or yttria stabilized zirconia and nickel and the porous cathode comprises doped lanthanum ferrite or strontium-doped lanthanum manganite and further wherein the anode, cathode, electrolyte or a combination of two or more of the foregoing are nanostructured.

12. The fuel cell of claim 11 further comprising an interlayer disposed between the electrolyte and the cathode.

13. The fuel cell of claim 11 further comprising an interlayer disposed between the electrolyte and the anode.

14. The fuel cell of claim 11, wherein the dense electrolyte has a porosity less than or equal to about 9%, based on the total volume of the electrolyte.

15. The fuel cell of claim 14, wherein the dense electrolyte has a porosity less than or equal to about 5%, based on the total volume of the electrolyte.

16. The fuel cell of claim 15, wherein the dense electrolyte has a porosity less than or equal to about 2%, based on the total volume of the electrolyte.

17. The fuel cell of claim 11, wherein the porous cathode, porous anode or both of the foregoing has a porosity greater than or equal to about 22%, based on the total volume of the electrode or electrodes.

18. The fuel cell of claim 11, wherein the electrolyte layer has a thickness of about 20 to about 200 micrometers.

19. The fuel cell of claim 11, wherein the cathode has a thickness of about 10 to about 200 micrometers.

20. The fuel cell of claim 11, wherein the anode has a thickness of about 10 to about 200 micrometers.

21. A fuel cell comprising a dense electrolyte comprising doped lanthanum gallate disposed between a porous nanostructured mixed ionic electronic conducting anode and a porous cathode comprising doped lanthanum ferrite or strontium-doped lanthanum manganite.

22. The fuel cell of claim 21 further comprising an interlayer disposed between the electrolyte and the cathode.

23. The fuel cell of claim 21 further comprising an interlayer disposed between the electrolyte and the anode.

24. The fuel cell of claim 21, wherein the dense electrolyte has a porosity less than or equal to about 9%, based on the total volume of the electrolyte.

25. The fuel cell of claim 24, wherein the dense electrolyte has a porosity less than or equal to about 5%, based on the total volume of the electrolyte.

26. The fuel cell of claim 25, wherein the dense electrolyte has a porosity less than or equal to about 2%, based on the total volume of the electrolyte.

27. The fuel cell of claim 21, wherein the porous cathode, porous anode or both of the foregoing has a porosity greater than or equal to about 22%, based on the total volume of the electrode or electrodes.

28. The fuel cell of claim 32, wherein the electrolyte has a thickness of about 20 to about 200 micrometers.

29. The fuel cell of claim 21, wherein the cathode has a thickness of about 10 to about 200 micrometers.

30. The fuel cell of claim 21, wherein the anode has a thickness of about 10 to about 200 micrometers.

31. The fuel cell of claim 21, wherein the anode comprises yttrium-doped strontium titanate, niobium-doped strontium titanate, yttrium/niobium-codoped strontium titanate or doped ceria.

32. A fuel cell comprising a dense electrolyte comprising doped lanthanum gallate disposed between a porous nanostructured mixed ionic electronic conducting anode and a porous mixed ionic electronic conducting cathode.

33. The fuel cell of claim 32, wherein the electrolyte is nanostructured.

34. A method to produce a solid oxide fuel cell comprising:
thermally spraying a material comprising yttrium-doped strontium titanate, yttrium-doped strontium titanate and nickel, doped ceria, lanthanum-doped ceria and nickel or yttria stabilized zirconia and nickel to form a porous anode;
thermally spraying a material comprising doped lanthanum gallate or yttria stabilized zirconia to form a dense electrolyte; and
thermally spraying a material comprising doped lanthanum ferrite or strontium-doped lanthanum manganite to form a porous cathode wherein the electrolyte is disposed between the cathode and the anode.

35. The method of claim 34 further comprising thermally spraying a material to form an interlayer disposed between the electrolyte and the anode.

36. The method of claim 34, further comprising thermally spraying a material to form an interlayer between the electrolyte and the cathode.
